(19) United States
(12) Patent Application Publication
(10) Pub. No.: US 2026/0218561 A1
(43) Pub. Date: Jul. 30, 2026

(54) Method for detecting movement for controlling an opening

(71) Applicant: SCHAEFFLER TECHNOLOGIES AG & CO. KG, Herzogenaurach (DE)

(72) Inventors: Wladia WASZAK, Toulouse (FR); Vincent MARIMOUTOU, Toulouse (FR); Maxime RATEAU, Toulouse (FR)

(73) Assignee: SCHAEFFLER TECHNOLOGIES AG & CO. KG, Herzogenaurach (DE)

(21) Appl. No.: 19/454,592

(22) Filed: Jan. 21, 2026

(30) Foreign Application Priority Data
Jan. 24, 2025 (FR) FR2500764

(51) Int. Cl. E05F 15/73

(52) U.S. Cl. CPC E05F 15/73; E05Y 2400/858; E05Y 2900/531

(57) ABSTRACT

A method for detecting movement for controlling an opening of a motor vehicle including a control system for controlling the opening. The control system includes a motor, an electronic control unit, a detection sensor including a control module, a first detection element and a second detection element, with the method, which is implemented by the detection sensor, includes the steps of detecting a gesture of the user, confirming the gesture, sending a control signal to the electronic control unit for activating the motor, deactivating the second detection element, sending a control signal to the electronic control unit for stopping the motor and reactivating the second detection element if a gesture is detected in a first detection zone.

### CROSS-REFERENCE TO RELATED APPLICATIONS

This application claims priority under 35 U.S.C. § 120 to French Application No. FR2500764 filed on Jan. 24, 2025, titled “Method for detecting movement for controlling an opening,” the entire disclosure of which is incorporated by reference herein.

### FIELD OF THE INVENTION

The present invention relates to the field of motor vehicles and more specifically relates to a system for controlling the opening and closing of a sliding door.

### BACKGROUND OF THE INVENTION

Several models of motor vehicles include sliding doors, notably rear sliding doors. These doors do not open by pivoting along an axis, but by shifting outwards and then sliding along the bodywork toward the rear of the vehicle.

Sliding doors were originally entirely manual, but have evolved to include a control system that motorizes the movement of the door, and allows the sole force of the arms of the user to be replaced for closing and opening them. To this end, the control system comprises at least one activation sensor, a computer, a motor and end-of-travel sensors.

When a gesture of the user is detected by the activation sensor, the computer receives this information and commands the activation of the motor, which moves the door. When the door is fully open or fully closed, the corresponding end-of-travel sensor sends the computer an end-of-travel signal, and the computer triggers the motor to stop.

Conventionally, the activation sensor is a handle that the user activates manually. This type of sensor is simple to install, but can be unsuitable in some situations, notably when the user is carrying heavy and bulky objects that they wish to load into the vehicle. If they cannot free-up one hand to open the door, they are forced to put down the relevant object before opening the door, then pick it up again to load it, thus requiring unnecessary movements and effort.

One solution is to use a sensor to detect a movement, notably of the foot, in a defined detection zone without requiring any contact with an element of the vehicle. For example, a solution exists that is already implemented for a rear hatch of the trunk of a vehicle with a radar sensor comprising two detection zones, thus providing greater reliability against external disruptions that could lead to false detections.

However, even if it is mounted on a fixed part, the sensor can pick up the movement of the door as it opens and closes. Any interference in the signal induced by this translation movement, notably in the detection zone intended for checking, is likely to generate false gesture detections, which could then cause the door movement to stop when the user wants it to open or close completely, or even could hide a gesture by the user when they want to interrupt the movement, which can present a safety risk.

An obvious solution would be to use a single detection zone. However, this would make the sensor measurements less reliable against any external disruptions when the door is stationary, fully open or fully closed.

Therefore, a requirement exists for a simple and effective solution for at least partly overcoming these disadvantages.

### SUMMARY OF THE INVENTION

To this end, an aspect of the invention firstly relates to a method for detecting movement for controlling an opening of a motor vehicle, notably for opening and closing a sliding door, said opening being configured to move between a closed position and a maximum open position, said vehicle comprising a control system for controlling the opening and closing of the opening, said control system comprising:
a motor configured to move the opening between its closed position and its maximum open position, and vice versa;
an electronic control unit configured to receive a control signal and to control said motor as a function of the received control signal;
a detection sensor comprising a control module, a first detection element configured to perform measurements in a first detection zone and a second detection element configured to perform measurements in a second detection zone, distinct from the first detection zone, said control module being configured to detect a gesture of a user in the first detection zone based on measurements performed by the first detection element and to send a control signal to the electronic control unit when a gesture of the user has been detected;
   said method, implemented by the detection sensor, comprising the steps of:
detecting a gesture of the user in the first detection zone and/or the second detection zone;
confirming the gesture of the user;
sending the electronic control unit a control signal for activating the motor;
deactivating the second detection element;
reactivating the second detection element if no gesture of the user is detected in the first detection zone until the opening reaches its closed position or its maximum open position;
sending a control signal to the electronic control unit to stop the motor and reactivating the second detection element if a gesture is detected in the first detection zone.

The method according to an aspect of the invention thus prevents, by deactivating the second detection element while the opening is moving, the second detection element from making false detections that could interrupt the movement or prevent the detection of another gesture by the user. Once the opening has stopped, whether it is in the closed position, the maximum open position or an intermediate position, the second detection element is reactivated, which ensures the conventional detection of a gesture of the user once the method is complete.

In a preferred operating mode, the control module for controlling the detection sensor is configured to increment a timer and to store a target duration in a memory corresponding to the time required for the opening to transition from its closed position to its maximum open position, and vice versa, and sending the signal to the electronic control unit is accompanied by the beginning of the incrementation of said timer, and the step of reactivating the second detection element if no gesture of the user is detected in the first detection zone until the opening reaches its closed position or its maximum open position is performed when the timer reaches the stored target duration. Thus, the detection sensor can autonomously reactivate the second detection element, without having to receive a specific signal sent by the electronic control unit.

In this operating mode, the timer is stopped if a gesture is detected during the translation movement of the opening. Preferably, if a second gesture is detected following an interruption in the translation movement, the motor is restarted in the opposite direction and the opening is translationally moved in order to return to its initial position before the first gesture.

Advantageously, the control module sends the detection signal to the electronic control unit after a short delay corresponding to the time for transmitting the signal to the electronic control unit and to the motor, so as to trigger the incrementation of the timer when the opening begins to move.

In an alternative operating mode, the control system further comprises a plurality of end-of-travel sensors configured to send a signal to the electronic control unit when the opening reaches its closed position or its maximum open position, the electronic control unit is configured to send an end-of-travel signal to the detection sensor after receiving a signal from one of the end-of-travel sensors, and the step of reactivating the second detection element if no gesture of the user is detected in the first detection zone until the opening reaches its closed position or its maximum open position is performed when the detection sensor receives the end-of-travel signal. The detection sensor is thus guaranteed to reactivate the second detection element when the opening reaches its closed position or its maximum open position.

According to another aspect, the invention also relates to a detection sensor comprising a control module, a first detection element and a second detection element, said detection sensor being configured to be mounted in an opening of a vehicle, said detection sensor being configured to be electrically connected to an electronic control unit, the first detection element being configured to perform measurements in a first detection zone, the second detection element being configured to perform measurements in a second detection zone, distinct from the first detection zone, and to send the measurements to the control module, said control module being configured to:
detect and confirm a gesture of a user based on the measurements performed by the first detection element and the second detection element;
send a control signal to the electronic control unit;
deactivate and reactivate the reception of signals from the second detection element.

This detection sensor is therefore capable of implementing the method according to an aspect of the invention.

In a preferred embodiment of the detection sensor described above, the first detection element and the second detection element are RADAR-type transceivers. This type of detection sensor is already used in the automotive industry and therefore allows the production and integration costs to be minimized.

In an alternative embodiment of the detection sensor described above, the first detection element and the second detection element are capacitive components whose electrical capacitance is modified by the gesture of the user.

Advantageously, the control module is configured to deactivate and reactivate the reception of signals from the second detection element by not taking into account the signals sent by the second detection element.

As a variant, the control module is configured to switch off and reactivate the second detection element and is configured to deactivate and reactivate the reception of signals from the second detection element by switching off and reactivating the second detection element. This thus ensures that the control module does not receive potentially disrupted signals from the second detection element while the opening is moving.

According to another aspect, the invention also relates to a control system for controlling an opening of a vehicle, said control system comprising a motor, an electronic control unit and a detection sensor as described.

According to another aspect, the invention also relates to a motor vehicle comprising an opening and a control system for controlling said opening as described.

### BRIEF DESCRIPTION OF THE DRAWINGS

Further features and advantages of aspects of the invention will become more clearly apparent from reading the following description. This is purely illustrative and should be read in conjunction with the appended drawings, in which:

FIG. 1 schematically illustrates an example of a motor vehicle comprising an opening and a control system according to an aspect of the invention;

FIG. 2 schematically illustrates an embodiment of the control system according to the invention;

FIG. 3 schematically illustrates an operating mode of the method according to an aspect of the invention.

### DETAILED DESCRIPTION OF EXEMPLARY EMBODIMENTS

The system according to an aspect of the invention allows a user to trigger the opening and/or closing of an opening 10 of a vehicle 1.

### Vehicle 1

The vehicle 1 comprises an opening 10 and a control system 20 for controlling the opening 10.

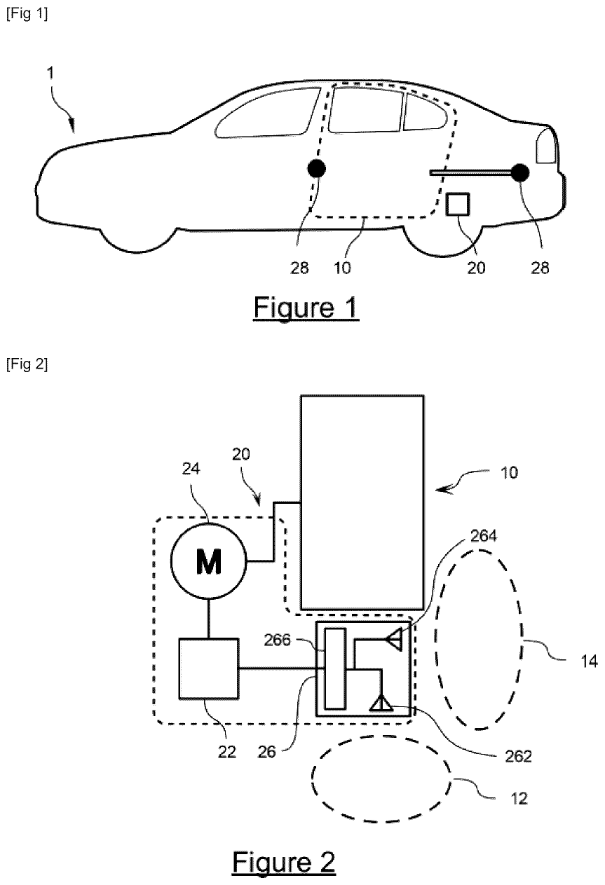

The opening 10 preferably is a door of the vehicle 1. In FIG. 1, the opening 10 is a rear door of the vehicle 1.

The opening 10 has a closed position and a maximum open position.

As shown in FIG. 2, two detection zones are defined around the opening 10: the first detection zone 12 and the second detection zone 14.

When the user performs a gesture to trigger the opening or closing of the opening 10, they perform the gesture in the first detection zone 12 while being in the second detection zone 14.

### Control System 20

As shown in FIGS. 1 and 2, the control system 20 comprises an electronic control unit 22, a motor 24, a detection sensor 26 and a set of end-of-travel sensors 28.

The electronic control unit 22 is configured to control the motor 24 as a function of signals sent by the detection sensor 26 and the end-of-travel sensors 28.

The motor 24 provides the motorization for the movement of the opening 10. Thus, if the opening 10 is in the closed position and the motor 24 receives an activation signal from the electronic control unit 22, the motor 24 is activated and opens the opening 10.

The motor 24 thus allows the opening 10 to move from its closed position to its maximum open position, and vice versa.

The motor 24 can receive an interruption signal that stops its operation, in the event that the opening 10 has reached either its closed position or its maximum open position, but also in the event that the user wishes to stop the movement of the opening 10 in an intermediate position.

The motor 24 is preferably located in the vehicle 1, but also can be located in the opening 10.

As shown in FIG. 2, the detection sensor 26 comprises a first detection element 262, a second detection element 264 and a control module 266.

In a preferred embodiment, the first detection element 262 and the second detection element 264 are RADAR transceivers, operating by sending an electromagnetic wave and receiving the reflection of the wave from a surface or an object.

More preferably, the first detection element 262 and the second detection element 264 are UWB (Ultra Wide Band) transceivers, operating at a frequency of 6.5 to 10 GHz.

In an alternative embodiment, the first detection element 262 and the second detection element 264 are components that measure the variation in the electric field caused by a gesture of the user, and in particular by measuring any variation in the electrical capacitance.

As shown in FIG. 2, the first detection element 262 is positioned so as to detect a gesture in the first detection zone 12 around the opening 10.

As shown in FIG. 2, the second detection element 264 is positioned so as to detect a gesture in the second detection zone 14 around the opening 10.

The first detection element 262 and the second detection element 264 send signals corresponding to any detection of any interference in the received signal in the first detection zone 12 and the second detection zone 14.

The control module 266 is configured to analyze the signals received from the first detection element 262 and the second detection element 264 in order to determine whether the detected interference is caused by a gesture of the user.

The control module 266 is configured to send an activation or interruption signal to the electronic control unit 22 when a gesture of the user has been detected.

The control module 266 is configured to deactivate the reception of signals transmitted by the second detection element 264.

Preferably, the control module 266 is configured to cut off the power supply to the second detection element 264 in order to deactivate the sending of signals.

Alternatively, the control module 266 is configured to ignore the signals transmitted by the second detection element 264.

The control module 266 is configured to trigger and increment a timer, and to compare the incremented time with a predetermined target duration. This target duration preferably corresponds to the duration of the movement of the opening 10 from its closed position to its maximum open position, and vice versa.

As shown in FIG. 1, the end-of-travel sensors 28 are installed in the vehicle 1 and detect the maximum positions of the opening 10. At least one end-of-travel sensor 28 detects the closed position of the opening 10, and at least one end-of-travel sensor 28 detects the maximum open position of the opening 10.

When the opening 10 is in its closed position or in its maximum open position, the end-of-travel sensors 28 send signals to the electronic control unit 22 to trigger the interruption of the motor 24.

For the sake of clarity, the end-of-travel sensors 28 are not shown in FIG. 2.

### Embodiment

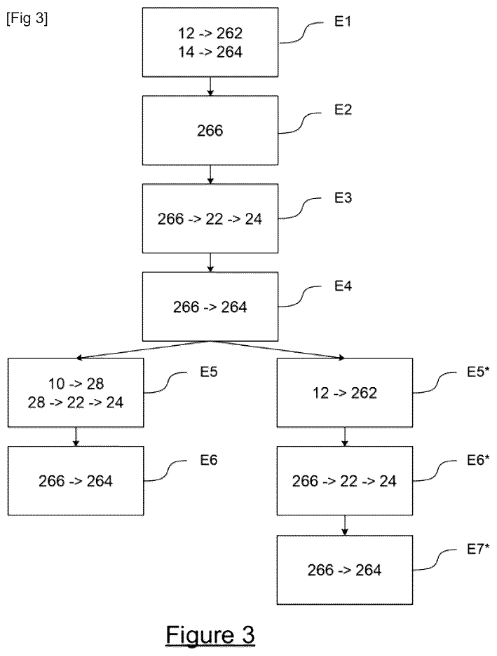

When a user wishes to trigger the opening of the door 10 of the vehicle 1, they perform a specific gesture that triggers the method according to an aspect of the invention, the sequence of which is shown in FIG. 3. The method is carried out in the same way when the user wishes to trigger the closure of the opening 10 from its maximum open position.

Preferably, the user performs a gesture involving a movement of the foot between the opening 10 and the ground, which mainly corresponds to the first detection zone 12.

In a first step E1, the first detection element 262 detects the gesture of the user in the first detection zone 12 and sends a signal to the control module 266. The gesture also can be detected by the second detection element 264, which also sends a signal to the control module 266.

As the user stands in the second detection zone 14, the second detection element 264 also detects the presence of the user and also sends a signal to the control module 266. Thus, if the user performs a gesture to trigger the opening 10 to open, the second detection element 264 detects the presence of the user and optionally the gesture in the first control zone 12, which ensures that the second detection element 264 necessarily sends a signal to the control module 266.

In a second step E2, upon receiving signals from the first detection element 262, the control module 266 checks that the second detection element 264 has also sent electrical signals, thus confirming the presence of the user and the opening gesture.

If the control module 266 receives signals from the first detection element 262 but not from the second detection element 264, the control module 266 determines that the detected gesture is not a gesture by a user wishing to open the opening 10, and the method is therefore interrupted.

The detection of a gesture in the first detection zone 12 and not in the second detection zone 14 can be caused by interference in the signal or even an object passing under the vehicle 1.

In a step E3, the control module 266 sends a trigger signal to the electronic control unit 22 to activate the motor 24.

In this step, the control module 266 also triggers a timer, which is incremented regularly, for example, every 0.5 seconds or even preferably every 0.1 seconds.

Preferably, the control module 266 triggers the incrementation of the timer after a predetermined duration, which allows the latency of the activation of the motor 24 after the trigger signal is sent to be taken into account. Triggering the timer thus corresponds to the beginning of the physical movement of the opening 10.

In a step E4, the control module 266 deactivates the second detection element 264, thereby interrupting the ability of the control system 20 to detect a gesture or the presence of a user in the second detection zone 14.

Thus, any interference in the signals picked up by the second detection element 264 generated by the movement of the opening 10, which could lead to false detections, is not taken into account by the control module 266. This interference can also hide a gesture by the user in the first detection zone 12 and thus prevent the movement of the opening 10 from being stopped despite the wish of the user.

If the user does not perform any further gestures while the opening 10 is moving, said opening reaches its maximum open position in a step E5.

The end-of-travel sensors 28 detect that the opening 10 has reached its maximum open position and sends interruption signals to the electronic control unit 22, which sends a motorization interruption signal to the motor 24.

Therefore, the motor 24 is stopped when the opening reaches its maximum open position.

The predetermined duration stored in the memory zone of the control module 266 corresponds to the duration of the movement of the opening 10 between its closed position and its maximum open position. The timer triggered in step E3 therefore reaches this predetermined duration in step E5.

When the timer reaches the predetermined duration, then, in a step E6, the control module 266 reactivates the second detection element 264, which was deactivated in step E4, and the method is completed.

The control system 20 is therefore once again able to detect the presence of a user in the second detection zone 14 in order to restart the method when the user performs a gesture to trigger the closure of the opening 10.

If the user performs an additional gesture in the first detection zone 12 while the opening 10 is moving, the gesture is detected by the first detection element 262 in a step E5*, which involves sending a signal to the control module 266.

Upon receiving this signal, the control module 266 sends an interruption signal to the electronic control unit 22 in a step E6* and interrupts the incrementation of the timer triggered during the step E4.

The electronic control unit 22 sends a motorization interruption signal to the motor 24. The movement of the opening 10 is therefore interrupted and the opening 10 is stopped in an intermediate position.

At the same time as the interruption signal is sent to the electronic control unit 22, then, in a step E7*, the control module 266 reactivates the second detection element 264 deactivated in the step E4.

Thus, if the user performs a gesture in the first detection zone 12 to resume opening the opening 10, the gesture indeed can be detected by the first detection element 262 and the presence of the user in the second detection zone 14 can be confirmed by the second detection element 264.

In this configuration, if the detection sensor 26 detects a second gesture in the first detection zone 12 after the movement of the opening 10 during its translation movement has stopped, the control module 266 sends the motor 24 a motorization signal commanding a translation movement opposite that of the opening 10 before detecting the second gesture.

Thus, if the opening 10 was translationally moving in order to open when the gesture interrupted its movement, the opening 10 closes following the second gesture. Conversely, if the opening 10 was translationally moving in order to close, the opening 10 reopens following the second gesture.

The detection module 26 again deactivates the second detection element 264 and decrements the timer incremented during the initial translation movement of the opening 10. Thus, when the timer reaches 0, the control module 266 detects that the opening 10 has returned to its initial position and reactivates the second detection element 264.

The end-of-travel sensors 28 detect that the opening 10 has reached the closed position or the maximum open position, and send the electronic control unit 22 a motorization interruption signal to command the motor 24 to stop.

Thus, the method according to an aspect of the invention allows the opening and closing of an opening 10 to be controlled, while ensuring that false detections and any shielding of the gestures of the user while the opening 10 is moving are avoided. Deactivating the second detection element 264 allows a detection sensor 26 to be used that is already used on the motor vehicle 1, thereby reducing the costs of the equipment of the motor vehicle 1.

1. A method for detecting movement for controlling an opening of a motor vehicle, notably for opening and closing a sliding door, said opening being configured to move between a closed position and a maximum open position, said vehicle comprising a control system for controlling the opening and closing of the opening, said control system comprising:
a motor configured to move the opening between its closed position and its maximum open position, and vice versa;
an electronic control unit configured to receive a control signal and to control said motor as a function of the received control signal;
a detection sensor comprising a control module, a first detection element configured to perform measurements in a first detection zone and a second detection element configured to perform measurements in a second detection zone, distinct from the first detection zone, said control module being configured to detect a gesture of a user in the first detection zone based on measurements performed by the first detection element and to send a control signal to the electronic control unit when a gesture of the user has been detected;
said method, implemented by the detection sensor, comprising:
detecting a gesture of the user in the first detection zone and/or the second detection zone;
confirming the gesture of the user;
sending the electronic control unit a control signal for activating the motor;
deactivating the second detection element;
reactivating the second detection element if no gesture of the user is detected in the first detection zone until the opening reaches its closed position or its maximum open position;
sending a control signal to the electronic control unit to stop the motor and reactivating the second detection element if a gesture is detected in the first detection zone;
wherein the control module for controlling the detection sensor is configured to increment a timer and to store a target duration in a memory corresponding to the time required for the opening to transition from its closed position to its maximum open position, and vice versa, and wherein sending the signal to the electronic control unit is accompanied by the beginning of the incrementation of said timer, and the step of reactivating the second detection element if no gesture of the user is detected in the first detection zone until the opening reaches its closed position or its maximum open position is performed when the timer reaches the stored target duration.

2. A detection sensor comprising a control module, a first detection element and a second detection element, said detection sensor being configured to be mounted in an opening of a vehicle, said detection sensor being configured to be electrically connected to an electronic control unit, the first detection element being configured to perform measurements in a first detection zone, the second detection element being configured to perform measurements in a second detection zone, distinct from the first detection zone, and to send the measurements to the control module, said control module being configured to:
detect and confirm a gesture of a user based on the measurements performed by the first detection element and the second detection element;
send a control signal to the electronic control unit;
deactivate and reactivate the reception of signals from the second detection element; and to:
increment a timer and to store a target duration in a memory corresponding to the time required for the opening to transition from a closed position to a maximum open position, and vice versa, and wherein sending the signal to the electronic control unit is accompanied by the beginning of the incrementation of said timer, and the step of reactivating the second detection element if no gesture of the user is detected in the first detection zone until the opening reaches its closed position or its maximum open position is performed when the timer reaches the stored target duration.

3. The detection sensor as claimed in claim 2, wherein the first detection element and the second detection element (264) are RADAR-type transceivers.

4. The detection sensor as claimed in claim 2, wherein the first detection element and the second detection element are capacitive components whose electrical capacitance is modified by the gesture of the user.

5. The detection sensor as claimed in claim 4, wherein the control module is configured to deactivate and reactivate the reception of signals from the second detection element by not taking into account the signals sent by said second detection element.

6. The detection sensor as claimed in claim 4, wherein the control module is configured to switch off and reactivate the second detection element and is configured to deactivate and reactivate the reception of signals from the second detection element by switching off and reactivating the second detection element.

7. A control system for controlling an opening of a vehicle, said control system comprising a motor, an electronic control unit (22) and a detection sensor as claimed in claim 2.

8. A motor vehicle comprising an opening and a control system for controlling said opening as claimed in claim 7.
